(19) United States
(12) Patent Application Publication
(10) Pub. No.: US 2024/0152869 A1
(43) Pub. Date: May 9, 2024

(54) SOFTWARE ASSESSMENT TOOL FOR MIGRATING COMPUTING APPLICATIONS USING MACHINE LEARNING

(71) Applicant: CDW LLC, Vernon Hills, IL (US)

(72) Inventors: Ryan Andrew Bandel, Artesia, CA (US); Thomas W. Dietz, Grand Rapids, MI (US)

(21) Appl. No.: 17/982,667

(22) Filed: Nov. 8, 2022

(51) Int. Cl. G06Q 10/10; G06Q 10/06; G06T 11/20

(52) U.S. Cl. CPC G06Q 10/103; G06Q 10/06313; G06T 11/206

(57) ABSTRACT

A computing system includes a processor; and a memory having stored thereon instructions that, when executed by the one or more processors, cause the system to: receive content migration project parameters, resource migration project parameters and one or more services parameters of a user; scan a tenant computing environment; process the parameters by applying a multiplier display the costs, profits and pricing information. A method includes receiving content migration project parameters, resource migration projecting parameters and one or more services parameters of a user; scanning a tenant computing environment; processing the parameters by applying a multiplier displaying the costs, profits and pricing information. A non-transitory computer readable medium includes program instructions that when executed, cause a computer to: receive content migration project parameters, resource migration project parameters and one or more services parameters of a user; scan a tenant computing environment; process the parameters by applying a multiplier display the costs, profits and pricing information.

### TECHNICAL FIELD

The present disclosure is generally directed to methods and systems for migrating computing applications using machine learning, and more particularly, techniques for identifying site resources and/or content resources and generating migration predictions using one or more trained machine learning models.

### BACKGROUND

A multi-brand provider of information technology solutions to international customers in the business, government, education and healthcare industries may provide a broad array of products and services ranging from hardware and software to integrated information technology solutions such as security, cloud computing, hybrid infrastructure and digital experience. Conventional techniques do not enable companies to systematically and predictably migrate software from one computing environment to another, without speculating about costs and resources utilization. Conventional techniques rely on best guesses of engineers or design consultants regarding prioritization, investment of time and investment/selection of resources needed to complete the migration task.

For example, the engineer or design consultant may ask the customer to describe the objects of the migration, (e.g., the software, data or services to be migrated). The customer may not know how to answer the question, or worse, may provide an inaccurate response. Furthermore, the migration engineer, design consultant, business intelligence professional and other personnel, whether relying on inaccurate information from the customer or not, may themselves inaccurately estimate the level of time and resources needed to complete the migration task, and/or assign subjective metrics (e.g., “easy,” “hard,” etc.) to sub-tasks within an overall migration task that do not accurately reflect migration difficulty. Moreover, the engineer or design consultant may not appreciate the scope of a given migration, and may not account for differences between different project types.

Therefore, improved methods and systems for performing systematic environment migration tasks are needed, that can accurately determine the scope of migrations, as well as technical requirements and other aspects of the migration.

### BRIEF SUMMARY

In one aspect, a computing system for improved migration of a tenant environment includes one or more processors; and a memory having stored thereon instructions that, when executed by the one or more processors, cause the system to: (i) receive, via the one or more processors, one or more content migration project parameters of a user; (ii) receive, via the one or more processors, one or more resource migration project parameters of a user; (iii) receive, via the one or more processors, one or more services parameters of a user; (iv) scan a tenant computing environment to identify, for each of a plurality of schemas, one or more respective signal values; (v) process the content migration project parameters, the resource migration parameters, the services parameters, and the respective signal values to determine costs, profits and pricing information corresponding to the migration of the tenant environment, wherein the processing includes applying at least one multiplier determined by a trained machine learning model; and (vi) cause the costs, profits and pricing information to be displayed on a display device.

In another aspect, a computer-implemented method for improved migration of a tenant environment includes: (i) receiving, via the one or more processors, one or more content migration project parameters of a user; (ii) receiving, via the one or more processors, one or more resource migration project parameters of a user; (ii) receiving, via the one or more processors, one or more services parameters of a user; (iv) scanning a tenant computing environment to identify, for each of a plurality of schemas, one or more respective signal values; (v) processing the content migration project parameters, the resource migration parameters, the services parameters, and the respective signal values to determine costs, profits and pricing information corresponding to the migration of the tenant environment, wherein the processing includes applying at least one multiplier determined by a trained machine learning model; and (vi) causing the costs, profits and pricing information to be displayed on a display device.

A non-transitory computer readable medium includes program instructions that when executed, cause a computer to: (i) receive, via the one or more processors, one or more content migration project parameters of a user; (ii) receive, via the one or more processors, one or more resource migration project parameters of a user; (iii) receive, via the one or more processors, one or more services parameters of a user; (iv) scan a tenant computing environment to identify, for each of a plurality of schemas, one or more respective signal values; (v) process the content migration project parameters, the resource migration parameters, the services parameters, and the respective signal values to determine costs, profits and pricing information corresponding to the migration of the tenant environment, wherein the processing includes applying at least one multiplier determined by a trained machine learning model; and (vi) cause the costs, profits and pricing information to be displayed on a display device.

### BRIEF DESCRIPTION OF THE FIGURES

The figures described below depict various aspects of the system and methods disclosed therein. It should be understood that each figure depicts one aspect of a particular aspect of the disclosed system and methods, and that each of the figures is intended to accord with a possible aspect thereof. Further, wherever possible, the following description refers to the reference numerals included in the following figures, in which features depicted in multiple figures are designated with consistent reference numerals.

FIG. 1 depicts an exemplary computing environment in which the techniques disclosed herein may be implemented, according to some aspects, according to some aspects.

FIG. 2 depicts an exemplary tenant migration summary graphical user interface (GUI) that includes summary statistics, in addition to determinations/predictions of one or more machine learning (ML) models, according to some aspects.

FIG. 3 depicts an exemplary tenant summary visualization GUI, according to some aspects.

FIG. 4 depicts an exemplary computer-implemented method, according to some aspects.

The figures depict preferred aspects for purposes of illustration only. One skilled in the art will readily recognize from the following discussion that alternative aspects of the systems and methods illustrated herein may be employed without departing from the principles of the invention described herein.

### DETAILED DESCRIPTION

### Overview

The present techniques provide methods and systems for, inter alia, assessing migration complexity using automated complexity assessment techniques, and machine learning (ML). For example, the present techniques include aspects directed to scanning one or more tenant environments to identify site resources and/or content resources, as well as for generating, by processing the site signals and content signals using one or more trained ML models, to predict migration outputs, and causing the migration prediction outputs to be acted upon (e.g., via displaying the outputs). The present techniques improve upon computing environment migration systems by, inter alia, providing reliable and repeatable techniques for accurately assessing the amount of time, money and resources required to effectuate migrations, without forcing migration engineers (or clients) to hazard subjective guesses as to the level of effort required.

In some aspects, the complexity assessment techniques may be parameterized to account for individual differences between migration projects. For example, a user (e.g., migration engineer or consultant) may select a complexity matrix for a migration project, a migration type for a project (e.g., phased migration or cutover migration, a number of available engineers, etc.). The present techniques may use the parameters for computing migration outputs.

In some aspects, the present techniques include instructions for processing the predictive outputs using rules and/or for visualizing the predictive outputs and/or for performing the migration steps based on the predictive output being approved by a client/customer and/or by the predictive output landing within a predetermined range.

The present techniques improve over conventional techniques for performing computing environment software-based migrations by automating the process of collecting an inventory of a cloud tenant environment (e.g., a Microsoft 365 tenant environment). The present techniques improve computing systems directed to performing automatic migration complexity assessment, visualization and automatic migration.

The tenant environment may include one or more tenant applications having different resource utilization profiles. For example, the tenant scanner (also referred to herein interchangeably as a crawler, spider or mapper) may discover capabilities of Microsoft applications including SharePoint sites, Microsoft Teams installations, OneDrive installations, Power Platform installations (e.g., Power Automate installations, Power Applications, Power Business Intelligence (BI) Applications), Azure Active Directory (AD) Users, Azure AD Groups, Microsoft Exchange Mailboxes, etc. In some aspects, the present techniques may be used to migrate additional/different technologies.

The tenant scanner may scan of other services/resources, such as databases, email servers, etc. of other third-party providers and in-house tools, services and/or resources to discover capabilities and gauge usage. The scanned resources need not be enumerated, because the present techniques may include instructions for automatically discover such resources.

Generally, the resources within the tenant environment(s) may include tenant resources, tenant content and/or tenant services. For example, in the context of a SharePoint-related migration, the tenant environment may include tenant resources (e.g., SharePoint sites, SharePoint webs, InfoPaths, web permissions, site groups, etc.), tenant content (e.g., SharePoint lists, SharePoint pages, workflows, etc.), tenant services (e.g., apps, teams, team channels, team tabs, team members, OneDrive users/user groups, mailboxes), etc. In some aspects, the tenant environment may include multiple respective sets of tenant resources, tenant content and resources/services (e.g., a production set, a teams set, a default set, a development set, etc.).

### Exemplary Computing Environment

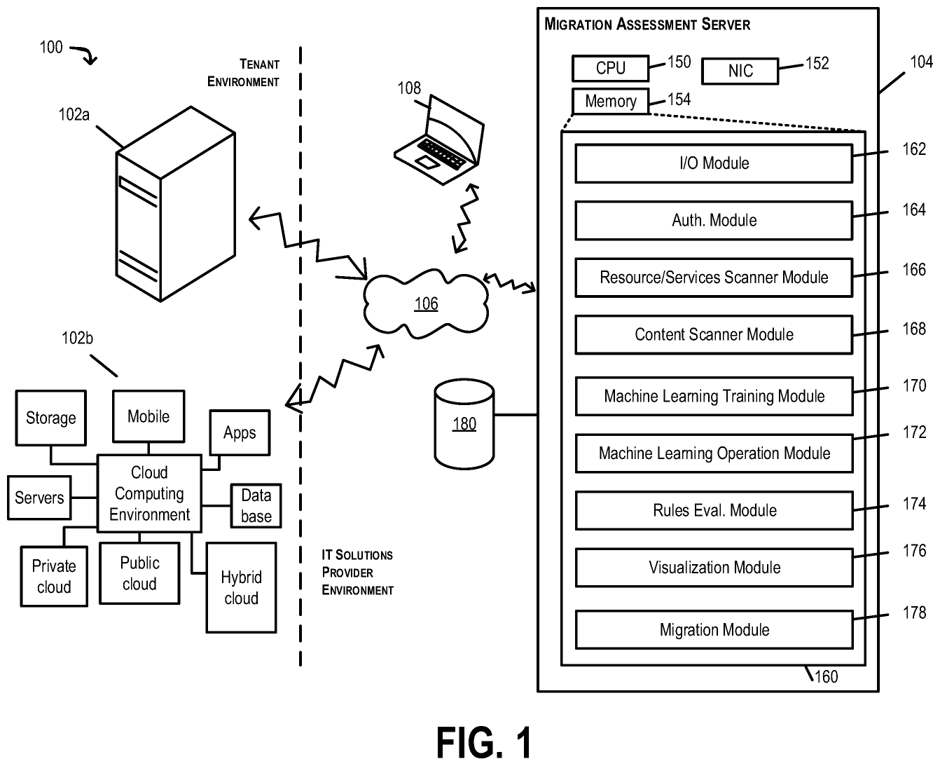

FIG. 1 depicts an exemplary computing environment 100 in which the techniques disclosed herein may be implemented, according to some aspects. The environment 100 includes a tenant computing environment and an information technology (IT) provider environment. The computing environment 100 may include one or more tenant computing devices 102a, 104b; a migration assessment server 104, a network 106 and a client computing device 108. Some aspects may include a plurality migration assessment servers 104.

The tenant computing devices 102a, 102b may each be an individual server, a group (e.g., cluster) of multiple servers, or another suitable type of computing device or system (e.g., a collection of computing resources). For example, the tenant computing device 102a may be any suitable computing device (e.g., a server, a mobile computing device, a smart phone, a tablet, a laptop, a wearable device, etc.). In some aspects, one or more components of the tenant computing devices 102a, 102b may be embodied by one or more virtual instances (e.g., a cloud-based virtualization service). The one or more tenant computing devices 102a, 102b may be included in a respective remote data center (e.g., a cloud computing environment, a public cloud, a private cloud, hybrid cloud, etc.).

The network 106 may be a single communication network, or may include multiple communication networks of one or more types (e.g., one or more wired and/or wireless local area networks (LANs), and/or one or more wired and/or wireless wide area networks (WANs) such as the Internet). The network 106 may enable bidirectional communication between the tenant computing devices 102a, 102b and the migration assessment server 104, and/or between other multiple tenant computing devices/instances, for example.

The tenant computing devices 102a, 102b each include a processor and a network interface controller (NIC). The processor may include any suitable number of processors and/or processor types, such as CPUs and one or more graphics processing units (GPUs). Generally, the processor is configured to execute software instructions stored in a memory. The memory may include one or more persistent memories (e.g., a hard drive/solid state memory) and stores one or more set of computer executable instructions/modules.

The tenant computing devices 102a, 102b may each includes a respective input device and a respective output device. The respective input devices may include any suitable device or devices for receiving input, such as one or more microphone, one or more camera, a hardware keyboard, a hardware mouse, a capacitive touch screen, etc. The respective output devices may include any suitable device for conveying output, such as a hardware speaker, a computer monitor, a touch screen, etc. In some cases, the input device and the output device may be integrated into a single device, such as a touch screen device that accepts user input and displays output. The tenant computing device may be associated with (e.g., owned/operated by) a company that services enterprise customers, and may include software licensed from a third party. For example, the tenant computing device 102a may be one of several tenant computing devices owned/leased by the company, each comprising a hosted Microsoft SharePoint site that services yet further customers.

The NIC of the tenant computing devices 102a, 102b may include any suitable network interface controller(s), such as wired/wireless controllers (e.g., Ethernet controllers), and facilitate bidirectional/multiplexed networking over the network between the tenant computing devices 102a, 102b and other components of the environment 100 (e.g., another tenant computing device (not depicted), the migration assessment server 104, an electronic database, etc.).

Each of the tenant computing devices 102a, 102b may include specific access controls that allow authenticated users (e.g., users or scripts of the migration assessment server 104) to access the tenant computing devices 102a, 102b. For example, the tenant computing device 102a may include instructions that allows authentication and querying of a SharePoint site. The tenant computing device 102b may include instructions that enable authentication and querying of an email server. These respective sets of instructions may be diverse, for example, one may be enabled by a closed-source software library, while the other may be enabled by a Free/Open Source software library. The configuration of APIs and access control is discussed further below from the perspective of the migration assessment server 104.

The migration assessment server 104 includes a processor 150, a network interface controller (NIC) 152 and a memory 154. The migration assessment server 104 may further include a database 180. The database 180 may be a structured query language (SQL) database (e.g., a MySQL database, an Oracle database, etc.) or another type of database (e.g., a not only SQL (NoSQL) database). The server 104 may include a library of client bindings for accessing the database 180. In some aspects, the database 180 is located remote from the migration assessment server 104. For example, the database 180 may be implemented using a RESTdb.IO database, an Amazon Relational Database Service (RDS), etc. in some aspects. In some aspects, the migration assessment server 104 may include a client-server platform technology such as Python, PHP, ASP.NET, Java J2EE, Ruby on Rails, Node.js, a web service or online API, responsive for receiving and responding to electronic requests.

The processor 110 may include any suitable number of processors and/or processor types, such as CPUs and one or more graphics processing units (GPUs). Generally, the processor 150 is configured to execute software instructions stored in the memory 154. The memory 154 may include one or more persistent memories (e.g., a hard drive/solid state memory) and stores one or more set of computer executable instructions/modules 160, including an input/output (I/O) module 162, an authentication module 164, a resource/service scanner module 166, a content scanner module 168, a machine learning training module 170, a machine learning operation module 172, a rules evaluation module 174, a visualization module 176; and a migration module 178.

Each of the modules 160 implements specific functionality related to the present techniques, as will be described further, below. In some aspects, a plurality of the modules 160 may implement a particular technique. For example, functionality provided by instructions within the authentication module 164 may be used by each of the respective content scanner module 166, resource scanner module 168 and services scanner module 166, to enable the migration assessment server 104 to access the tenant environment. Thus, the modules 160 may exchange data via suitable techniques, e.g., via inter-process communication (IPC), a Representational State Transfer (REST) API, etc. within a single computing device, such as the migration assessment server 104. Or, in aspects wherein the migration assessment server 104 is implemented using multiple servers, a first server may include the authentication module 164 while two other respective servers include the content scanner module 166 and the services scanner module 166, for example. In some aspects a plurality of the modules 160 may be implemented in a plurality of computing devices (e.g., a plurality of servers 104). The modules 160 may exchange data among the plurality of computing devices via a network such as the network 106. The modules 160 of FIG. 1 will now be described in greater detail.

Generally, the I/O module 162 includes instructions that enable a user (e.g., an employee of the company) to access and operate the migration assessment server 104 (e.g., via the client computing device 108). For example, the employee may be a software developer who trains one or more ML models using the ML training module 172 in preparation for using the one or more trained ML models to generate outputs used in a migration assessment project. Once the one or more ML models are trained, the same user may access the migration assessment server 104 via the I/O module to cause the migration assessment process to be initiated. The I/O module 162 may include instructions for generating one or more graphical user interfaces (GUIs) that collect and store parameters related to the migration assessment project, such as a migration project name (e.g., Example Migration), a migration project domain name/internet protocol (IP) address (e.g., http://exampleprodev.onmicrosoft.com), a portal uniform resource locator (URL) (e.g., http://exampleportal.sharepoint.com), a root site URL (e.g., http://example.sharepoint.com), an administrator URL (e.g., http://example-admin.sharepoint.com), one or more site URL (e.g., http://example-site.sharepoint.com), a default location toggle, etc.

The I/O module 162 may also include GUI features that enable the user to initiate a scanning process, after one or more migration assessment project parameters are collected and stored. For example, the I/O module 162 may include instructions for receiving a user selection of the project Example Migration project and its related parameters, and to initiate a scan of the one or more domain names, one or more IP addresses and/or one or more URLs associated with the Example Migration project. The I/O module 162 may communicate a start scan instruction to the scanner modules, discussed below. The I/O module 162 may include a library of functions that enable the user to perform “pre-flight” operations with respect to one or more services/resources associated with the migration project. For example, it may be highly desirable prior to performing a migration to cause a backup to occur, and/or to place a service/resource into a read-only mode. The pre-flight instruction sets of the I/O module may include instructions enable the user to selectively backup and/or make read-only certain resources/services associated with the project, including those that are discovered by the scanning process described below. The I/O module 162 may include a communication component configured to communicate (e.g., send and receive) data via one or more external/network port(s) to one or more networks or local terminals, such as client device 108 (for rendering or visualizing) described herein.

The authentication module 164 may include instructions for authenticating via one or more authentication methods to the heterogeneous content, resources and services of the tenant environment. For example, the authentication module 164 may include software client libraries for accessing the company's own Identity Provider (IdP) or default Azure Active Directory (Azure AD) IdP. The authentication module 164 may store one or more cookie or persistent session (e.g., a Federation Authentication (FedAuth) cookie) in association with each project (e.g., the Example Project discussed above). The authentication module 164 may also store and/or access (e.g., via the electronic database 180) one or more certificate for accessing certificate-based authentication resources/services (e.g., public key cryptography, Secure Shell (SSH)) services, Secure Sockets Layer services, etc.). Generally, the authentication module 164 may include a software library for authenticating via any suitable authentication mechanism, using stored credentials. In some aspects (e.g., multi-factor authentication aspects) the authentication module 164 may receive one-use passwords from a user (e.g., via the I/O module 162).

The resource/service scanner module 166 may include computer-executable instructions for scanning one or more remote resources/services and for generating one or more respective site signals associated with each remote resource/service. For example, the resources/services scanner module 166 may authenticate to a SharePoint site using the parameters of the Example Migration discussed above (e.g., by accessing the root site URL). The resources/services scanner module 166 may include instructions for crawling the root site URL (e.g., via a URL spidering technique) to interrogate the SharePoint site to discover sub-sites belonging to the SharePoint site. For example, a SharePoint site may have a root site called ProDev Root that links to additional sites. The output of the service/scanner module 166 site scanning instructions may be an alphabetized list of discovered site URLs/titles (e.g., sorted alphabetically) as in the following excerpt:
https://exampleprodev.sharepoint.com/portals/community Community
https://exampleprodev.sharepoint.com/portals/hub PointPublishing Hub Site
https://exampleprodev.sharepoint.com/portals/personal/suthree suthree
https://exampleprodev.sharepoint.com/sites/aaho365groupmigrationtest TEST GROUP Group Migration Test
https://exampleprodev.sharepoint.com/sites/aaho365teammigrationtest TEST GROUP Team Migration Test
https://exampleprodev.sharepoint.com/sites/acc ACC
https://exampleprodev.sharepoint.com/sites/accounting Accounting
https://exampleprodev.sharepoint.com/sites/accounting-accountspayable Accounting-Accounts Payable
https://exampleprodev.sharepoint.com/sites/bpa Business Process Automation (BPA) [ . . . ]
https://exampleprodev.sharepoint.com/teams/stolencars Stolen Cars
https://exampleprodev.sharepoint.com/teams/stolencarsproject Stolen Cars Project
https://exampleprodev.sharepoint.com/teams/stolencarsproject-federalreports Stolen Cars Project—Federal reports
https://exampleprodev.sharepoint.com/teams/teamone Team One
https://exampleprodev.sharepoint.com/teams/teamstest01 TeamsTest01
https://exampleprodev.sharepoint.com/teams/tms-demoteam1 TMS-DemoTeam1
https://exampleprodev.sharepoint.com/teams/tms-demoteams2 TMS-DemoTeams2
https://exampleprodev.sharepoint.com/teams/tms-testapp1 TMS-TestApp1
https://exampleprodev.sharepoint.com/teams/viksfoodonastick Test'sFoodonastick
https://exampleprodev.sharepoint.com/teams/vikshotdogs Test'sHotDogs
https://exampleprodev.sharepoint.com/teams/viksicecream Test'sIce Cream
https://exampleprodev.sharepoint.com/teams/viksitalian Test'sItalian
https://exampleprodev.sharepoint.com/teams/vikspizzarea Test'sPizzeria
https://exampleprodev.sharepoint.com/teams/TestTeamstest01 TestTeamsTest01
https://exampleprodev.sharepoint.com/teams/TestTeamstest02 TestTeamsTest02
https://exampleprodev.sharepoint.com/teams/sitetest2 Sitetest2
https://exampleprodev.sharepoint.com/teams/testingtest Testing Test

The resource/service scanner module 166 may store the discovered sites URLs in a temporary database table of the database 108, and then for each site, perform further scans. For example, the resource/services scanner 166 may include instructions that determine, for each site, a number of mailboxes, a number of teams, a number of SharePoint sites, a number of applications built, a number of workstations/laptops installed, a number of users, respective configuration information, etc.

The resource/services scanner module 166 may generate the site signals in response to the scanning. For example, resource/services scanner module 166 may generate, with respect to each of the above sites, the following site signals: Site Type (SharePoint, Teams, etc.), Storage Use (GiB), Webs (Count), Lists (Count), Libraries (Count), Items (Count), Apps (Count), Non-Default Lists (Count), Web Unique Permissions (Count), List Unique Permissions (Count), Item Folder Unique Permissions (Count), Time Create (Timestamp), Time Modified (Timestamp), Created By (User ID), Visibility (Boolean), Is Hub Site (Boolean), Has Holds (Boolean), Lock State (Read-Only, Unlocked, etc.), Owner (User ID), Sharing State (Disabled, ExternalUsersOnly, InternalUsersOnly, etc.), Customizing Enabled (Boolean), Tenant (Tenant ID), Status (ok, fail, warn), etc. The resource/services scanner 166 may include instructions that generate a site identifier (e.g., a universally unique identifier (UUID)) for each identified site, and the site ID may be used, for example, as a primary key for storing the site and related (e.g., site signal, webs, etc.) information in the electronic database. The resource/services scanner module 166 may store each of the generated site signals in association with each of the discovered sites, in the electronic database.

Continuing the above SharePoint example, the resources/services scanner module 166 may include further instructions for crawling the SharePoint site to discover webs. For example, the output of the resources/services scanner module 166 webs scanning instructions may be an alphabetized list of discovered webs. Each of the discovered webs may be associated, many-to-one, with the above-described sites. In other words, a given site, such as the Community site, may include one or more associated webs, and each of the webs may include its own set of webs signals, much as the sites include site signals. For example, the resources/services scanner module 166 webs scanning instructions may discover, by scanning the above BPA site (https://exampleprodev.sharepoint.com/sites/bpa), the following webs/titles:
https://exampleprodev.sharepoint.com/sites/BPA/ACME/Ideas NewIdeas
https://exampleprodev.sharepoint.com/sites/BPA/ACME ACME
https://exampleprodev.sharepoint.com/sites/BPA/BrandonSite Brandon Site
https://exampleprodev.sharepoint.com/sites/BPA/johnny-k2-appit Johnny K2 AppIt
https://exampleprodev.sharepoint.com/sites/BPA/K2Trainer K2 Trainer
https://exampleprodev.sharepoint.com/sites/BPA/MK2Training MaggiK2Training
https://exampleprodev.sharepoint.com/sites/BPA/Sam/RecCenter Records Center
https://exampleprodev.sharepoint.com/sites/BPA/Sam Sam Site
https://exampleprodev.sharepoint.com/sites/BPA/vappit User1 AppIT
https://exampleprodev.sharepoint.com/sites/BPA Business Process Automation

As the resources/scanner module 166 generates a set of site signals for each of the site URLs, the resources/scanner module 166 may generate a set of webs signals with respect to each of the discovered webs, that may also include one or more of the site signals: Generation (Modern, Classic, Template, StorageUsed (MiB), Webs (Count), Lists (Count), Libraries (Count), Items (Count), Has Unique Permission (Boolean), Non-Default Lists (Count), List Unique Permissions (Count), Item Folder Unique Permissions (Count), Created (Timestamp), Modified (Timestamp), Created By (User Id), etc. The webs signals may include a site ID (e.g., UUID) corresponding to a site UUID. The resources/scanner module 166 may store the generated signals in the database 180.

The content scanner module 168 may include instructions for analyzing the sites and webs discovered by the resource/service scanner module 166. With respect to a given site and/or web, the content scanner module 168 may crawl the associated URLs and discover one or more lists, each of the lists including a set of lists signals. For example, with respect to the business process automation site (BPA), and each of the discovered webs therein, the content scanner module 168 may discover one or more exemplary lists. For example, the site https://exampleprodev.sharepoint.com/sites/BPA may be associated with one or more webs. A web might be, e.g., https://exampleprodev.sharepoint.com/sites/BPA/ACME. For example, this web might include a plurality of lists, e.g., Cars, Contact List, Documents, Planes, etc. The content scanner module 168 may generate list content signals with respect to each of the lists, including Storage Used (MiB), Items (Count), Versions (Count), Items Folder Unique Permissions (Count), Non Default List (Count), Created (Count), Modified (Count), Checked Out Files (Count), Choice Fields (Count), Fields (Count), Required Fields (Count), Version History Enabled (Count), List Form Customized (Count), etc. Each list may have an identifier (e.g., a list UUID) may be associated via an identifier (e.g., a webs UUID) to a webs and/or a site (e.g., via a site UUID).

In addition to the above-discussed Lists example (or alternatively, in some aspects), the content scanner module 168 may scan the respective webs to discover one or more pages, workflows, infopaths, web permissions, site groups, teams, team channels, team members, one drive installations, users, groups, group members, mail messages, environments, dataverses, flows, flow connections, power applications, power application connections, capacities, licenses, business intelligence workspaces, etc. Each of these scanned content types may include a respective set of signals that the content scanner module 168 may populate and store in the electronic database 180. For example, the license content type may include signals including a service identifier, a license name, a license date (Timestamp), an is trial indicator (Boolean), etc. Those of ordinary skill in the art will appreciate that exhaustive enumeration of all potential signals and signal values is not necessary. Further, the sites, webs, and content types discussed herein are for exemplary purposes only, and in production environments, many (e.g., thousands or more) additional resources/services and content may be mapped by the module 166 and the module 168. The resource/services scanner module 166 and/or the content scanner module may organize the signals data into one or more data schemas reflective of the tenant environment.

### Exemplary Data Schemas

In some aspects, the schemas may include respective schemas directed to a number of different signals, such as ([‘Tenants’, ‘Sites’, ‘Webs’, ‘Lists’, ‘Pages’, ‘Workflows’, ‘Infopath’, ‘WebPermissions’, ‘SiteGroups’, ‘SPApps’, ‘Teams’, ‘TeamChannels’, ‘TeamTabs’, ‘TeamMembers’, ‘OneDrive’, ‘Users’, ‘Groups’, ‘GroupMembers’, ‘Mail’, ‘Environments’, ‘Dataverse’, ‘Flows’, ‘FlowConnections’, ‘FlowActions’, ‘PowerApps’, ‘Portals’, ‘PowerAppConnections’, ‘Capacities’, ‘PowerDLP’, ‘Licenses’, ‘BIWorkspaces’, ‘BIWorkspaceUsers’, ‘BIReports’, ‘BIDashboards’, ‘BIDatasets’, ‘BIDatasources’, ‘BIDataflows’, ‘SitesAdminLog’, ‘TeamsAdminLog’, ‘Errors’]). However, this is merely one possible example set of set of schemas for illustration purposes. In some aspects, more, or fewer, schemas may be used.

In the example below, for brevity, each schema includes the first 20 rows of exemplary data values, if any. In some instances, more or fewer rows may be included in the respective schemas.

Each of the schemas may include one or more columns, or fields. These fields may be populated with rows of data, and the rows of data may, in some cases, be functions that reference rows/columns within the same schema and/or different schemas, as shown below. In the example below, individual values (i.e., cells or row/column pairs) that include formulas are shown within double brackets (“[[ ]]”) alongside the evaluated values of such formulas. Further, to preserve privacy/anonymity, the schemas may include representative values beginning with a dollar sign for a plurality of field types, such as $EMAIL_ADDRESS, $URL, $IP (for IP addresses), $NRP (for nationality, religious or political information), $LOCATION, $PERSON, $PHONE_NUMBER, $DATE_TIME, etc.

While the schemas are depicted for simplicity's sake in the following example as being in a quasi-spreadsheet format, the schemas may be readily imported into another data format (e.g., Structured Query Language (SQL), eXtensible Markup Language (XML), comma-separated values (CSV), a flat file database, an in-memory database, etc.). For example, with continued reference to FIG. 1, some or all of the schemas may be stored in the database 180. Herein, the values in the schemas below (e.g., the data in an instance of a given schema) may be referred to as “signal values” or, simply “values.”

### Exemplary Schema Population and Use

As discussed above, in some aspects, the schemas are populated with data by the modules 160. For example, the modules 160 may include one or more modules that crawl the tenant environment of the environment (e.g., the tenant computing devices 102b) to retrieve values. The values may be stored in the respective schemas. Once the one or more schemas are populated with information, the information may be analyzed, for example, one or more models trained by the machine learning training module 170 that are executed by the machine learning operation module 172.

### Exemplary Computer-Implemented Machine Learning Model Training and Model Operation

In general, a computer program or computer based product, application, or code (e.g., the model(s), such as machine learning models, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor(s) 150 (e.g., working in connection with the respective operating system in memory 154) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C #, Objective-C, Java, Scala, ActionScript, JavaScript, HTML, CSS, XML, etc.).

For example, in some aspects, the ML model training module 172 may include a set of computer-executable instructions implementing machine learning training, configuration, parameterization and/or storage functionality. The ML model training module 172 may initialize, train and/or store one or more ML models, as discussed herein. The trained ML models may be stored in the database 180, which is accessible or otherwise communicatively coupled to the migration assessment server 104. The modules 160 may store machine readable instructions, including one or more application(s), one or more software component(s), and/or one or more APIs, which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein.

The ML training module 172 may train one or more ML models (e.g., an artificial neural network (ANN)). One or more training data sets may be used for model training in the present techniques, as discussed herein. The input data may have a particular shape that may affect the ANN network architecture. The elements of the training data set may comprise tensors scaled to small values (e.g., in the range of (−1.0, 1.0)). In some aspects, a preprocessing layer may be included in training (and operation) which applies principal component analysis (PCA) or another technique to the input data. PCA or another dimensionality reduction technique may be applied during training to reduce dimensionality from a high number to a relatively smaller number. Reducing dimensionality may result in a substantial reduction in computational resources (e.g., memory and CPU cycles) required to train and/or analyze the input data.

In general, training an ANN may include establishing a network architecture, or topology, adding layers including activation functions for each layer (e.g., a “leaky” rectified linear unit (ReLU), softmax, hyperbolic tangent, etc.), loss function, and optimizer. In an aspect, the ANN may use different activation functions at each layer, or as between hidden layers and the output layer. A suitable optimizer may include Adam and Nadam optimizers. In an aspect, a different neural network type may be chosen (e.g., a recurrent neural network, a deep learning neural network, etc.). Training data may be divided into training, validation, and testing data. For example, 20% of the training data set may be held back for later validation and/or testing. In that example, 80% of the training data set may be used for training. In that example, the training data set data may be shuffled before being so divided. Data input to the artificial neural network may be encoded in an N-dimensional tensor, array, matrix, and/or other suitable data structure. In some aspects, training may be performed by successive evaluation (e.g., looping) of the network, using training labeled training samples. The process of training the ANN may cause weights, or parameters, of the ANN to be created. The weights may be initialized to random values. The weights may be adjusted as the network is successively trained, by using one or more gradient descent algorithms, to reduce loss and to cause the values output by the network to converge to expected, or “learned”, values. In an aspect, a regression may be used which has no activation function. Therein, input data may be normalized by mean centering, and a mean squared error loss function may be used, in addition to mean absolute error, to determine the appropriate loss as well as to quantify the accuracy of the outputs. In some aspects, the present techniques may include one or more ML models that perform a regression analysis.

In various aspects, an ML model, as described herein, may be trained using a supervised or unsupervised machine learning program or algorithm. The machine learning program or algorithm may employ a neural network, which may be a convolutional neural network, a deep learning neural network, and/or a combined learning module or program that learns in two or more features or feature datasets (e.g., structured data, unstructured data, etc.) in a particular areas of interest. The machine learning programs or algorithms may also include natural language processing, semantic analysis, automatic reasoning, regression analysis, support vector machine (SVM) analysis, decision tree analysis, random forest analysis, K-Nearest neighbor analysis, naïve Bayes analysis, clustering, reinforcement learning, and/or other machine learning algorithms and/or techniques. In some aspects, the artificial intelligence and/or machine learning based algorithms may be based on, or otherwise incorporate aspects of one or more machine learning algorithms included as a library or package executed on server(s) 104. For example, libraries may include the TensorFlow based library, the Pytorch library, and/or the scikit-learn Python library.

Machine learning may involve identifying and recognizing patterns in existing data (such as data risk issues, data quality issues, sensitive data, etc.) in order to facilitate making predictions, classifications, and/or identifications for subsequent data (such as using the models to determine or generate a classification or prediction for, or associated with, the level of effort (e.g., person-hours and cost) necessary to perform a migration). Machine learning model(s), may be created and trained based upon example data (e.g., “training data”) inputs or data (which may be termed “features” and “labels”) in order to make valid and reliable predictions for new inputs, such as testing level or production level data or inputs. In supervised machine learning, a machine learning program operating on a server, computing device, or otherwise processor(s), may be provided with example inputs (e.g., “features”) and their associated, or observed, outputs (e.g., “labels”) in order for the machine learning program or algorithm to determine or discover rules, relationships, patterns, or otherwise machine learning “models” that map such inputs (e.g., “features”) to the outputs (e.g., labels), for example, by determining and/or assigning weights or other metrics to the model across its various feature categories. Such rules, relationships, or otherwise models may then be provided subsequent inputs in order for the model, executing on the server, computing device, or otherwise processor(s), to predict, based on the discovered rules, relationships, or model, an expected output. For example, the ML training module 172 may analyze labeled historical data at an input layer of a model having a networked layer architecture (e.g., an artificial neural network, a convolutional neural network, a deep neural network, etc.) to generate ML models. The training data may be, for example, historical data related to migrations previously performed by the company. The historical data may include labels that indicate, for a given migration, a mapping of resources, services and/or content to complexity/cost to signals. The mapping may be generated by analyzing log files generated during prior migrations. During training, the labeled data may be propagated through one or more connected deep layers of the ML model to establish weights of one or more nodes, or neurons, of the respective layers. Initially, the weights may be initialized to random values, and one or more suitable activation functions may be chosen for the training process, as will be appreciated by those of ordinary skill in the art. One or more ML models may be trained to predict hours/cost based on signals, and the ML training module 172 may include training a respective output layer of the one or more machine learning models. The output layer may be trained to output a prediction, for example.

The prediction may include a number of estimated hours for migrating a given site. In some aspects, the prediction may include a cost. The predicted hours and/or cost may be compared and analyzed, e.g., via the rules evaluation module 174, to calculate a cost of performing a given migration. In some aspects, the ML training module 172 may train a classifier that classifies the migration into a pre-determined class, based on the predicted time/cost required to perform the migration.

The data used to train the ANN may include heterogeneous data (e.g., textual data, image data, audio data, etc.). In some aspects, multiple ANNs may be separately trained and/or operated. In some aspects, the present techniques may include using a machine learning framework (e.g., Keras, scikit-learn, etc.) to facilitate the training and/or operation of machine learning models.

In unsupervised machine learning, the server, computing device, or otherwise processor(s), may be required to find its own structure in unlabeled example inputs, where, for example multiple training iterations are executed by the server, computing device, or otherwise processor(s) to train multiple generations of models until a satisfactory model, e.g., a model that provides sufficient prediction accuracy when given test level or production level data or inputs, is generated. In the present techniques, unsupervised learning may be used, inter alia, for natural language processing purposes and to identify scored features that can be grouped to make unsupervised decisions (e.g., numerical k-means). Supervised learning and/or unsupervised machine learning may also comprise retraining, relearning, or otherwise updating models with new, or different, information, which may include information received, ingested, generated, or otherwise used over time. The present techniques may use one or both of such supervised or unsupervised machine learning techniques. In various aspects, training the ML models herein may include generating an ensemble model comprising multiple models or sub-models, comprising models trained by the same and/or different AI algorithms, as described herein, and that are configured to operate together.

The architecture of the ML model training module 170 and the ML operation module 172 as separate modules represent advantageous improvements over the prior art. In conventional computing systems that include multiple machine learning algorithms, for performing various functions, the models are often added to each individual module or set of instructions independent from other algorithms/modules. This is wasteful of storage resources, resulting in significant code duplication. Further, repeating ML model storage in this way may result in redundant retraining of the same model aspects, wasting computational resources. By consolidating ML model training and ML model operation into two respective modules that may be reused by any of the various ML algorithms/modeling suites of the present techniques, waste of storage and computation is avoided. Further, this organization enables computational training work to be organized by a task scheduling module (not depicted), for efficiently allocating computing resources for training and operation, to avoid overloading the underlying system hardware, and to enable training to be performed using distributed computing resources (e.g., via the network 106) and/or using parallel computing strategies.

Once the model training module 170 has initialized the one or more ML models, which may be ANNs or regression networks, for example, the model training module 170 trains the ML models by inputting labeled data into the models (e.g., labeled historical migration log files that include signal data, wherein the labels correspond to cost/migration time). For example, an installation with 50 users may have required a given amount of time. The trained ML model may be expected to provide a similar cost, other things being equal, for inputs corresponding to a de novo site having 49 users, as opposed to a de novo site having 2 users (or 2000, or more). The model, when also trained using signals that correspond to different site/webs/content configurations/customizations, can be expected to provide even more accurate predictions.

The model training module 170 may divide the labeled data into a respective training data set and testing data set. The model training module 170 may train the ANN using the labeled data. The model training module 170 may compute accuracy/error metrics (e.g., cross entropy) using the test multidimensional image data and test corresponding sets of labels. The model training module 170 may serialize the trained model and store the trained model in a database (e.g., the database 180). Of course, it will be appreciated by those of ordinary skill in the art that the model training module 170 may train and store more than one model. For example, the model training module 170 may train an individual model for each site type. It should be appreciated that the structure of the network as described may differ, depending on the aspect.

In some aspects, the computing modules 160 may include a machine learning operation module 172, comprising a set of computer-executable instructions implementing machine learning loading, configuration, initialization and/or operation functionality. The ML operation module 172 may include instructions for storing trained models (e.g., in the electronic database 180, as a pickled binary, etc.). Once trained, a trained ML model may be operated in inference mode, whereupon when provided with de novo input that the model has not previously been provided, the model may output one or more predictions, classifications, etc. as described herein. In an unsupervised learning aspect, a loss minimization function may be used, for example, to teach a ML model to generate output that resembles known output (i.e., ground truth exemplars).

Once the model(s) are trained by the model training module 170, the model operation module 172 may load one or more trained models (e.g., from the database 180). The model operation module 172 applies new data that the trained model has not previously analyzed to the trained model. For example, the model operation module 172 may load a serialized model, deserialize the model, and load the model into memory. The model operation module 172 may load new migration data that was not used to train the trained model. For example, the new customer data may include signals data stored by the resource/service scanner module 166 and/or the content scanner module 168, as described above, encoded as input tensors. The model operation module 172 may apply the one or more input tensor(s) to the trained ML model. The model operation module 172 may receive output (e.g., tensors, feature maps, etc.) from the trained ML model. The output of the ML model may be a prediction of the time/cost associated with migrating the resources/content. In this way, the present techniques advantageously provide a means for the company to quantitatively estimate migration timelines, without resorting to “best guesses” or other subjective metrics used in conventional industry practices.

The model operation module 172 may be accessed by another element of the migration assessment server 104 (e.g., a web service). The ML operation module 172 may pass its output to the rules evaluation module 174 for further processing/analysis. Alternatively, the rules evaluation module 174 may receive results stored by the ML operation module 172 in the electronic database 180. For example, the rules evaluation module 174 may evaluate the output of the ML operation module 172 using a set of rules, to determine whether the predictions make sense in a business context to a user. For example, the rules evaluation module 174 may include computer-executable instructions, that when executed, cause the migration assessment server 104 to retrieve a time prediction for migrating a site, for example, of the tenant environment to another computing environment (e.g., a new tenant environment (not depicted)). The rules evaluation module 174 may analyze the time prediction and generate a services summary that includes estimates of total hours required on a per phase basis for multiple tasks across multiple functional groups, broken down according to different user types.

The visualization module 176 may include instructions for processing data stored in the schemas and for generating one or more visual representations of that data, in the form of static images (e.g., graphs, charts, diagrams, etc.) and/or animated or video-based outputs.

In some aspects, the modules 160 may include more or fewer modules. For example, in some aspects, the modules 160 may include instructions for performing a migration once a suitable migration plan has been identified.

In operation, a user (e.g., a migration engineer, financial planner, consultant, etc.) accesses the migration assessment server 104. For example, the user may use the client computing device 108, or the server 104 directly via peripheral devices (not depicted in FIG. 1). The user accesses the server 104 via the I/O module 162 and initiates and parameterizes a migration project, as discussed above. The user may initiate the scanning process to collect initial information from the tenant environment.

For example, the user may enter content migration parameters such as the size of data to migrate, a ShareGate server count (from 0-3, for example), a size of mailbox data to migrate, a number of tenant messages to migrate, etc. The parameters may span multiple products, such as SharePoint, Exchange, OneDrive, Teams, and/or others. In some aspects, the user may initiate a scan of the client's environment prior to performing the parameterization. In some aspects, the user may not parameterize the migration project, and/or may parameterize the migration project based on default parameters. The user may also view and/or adjust existing parameters.

The user may enter resource migration parameters. In some aspects, the user may select from discovered totals. For example, the scanning process may discover that the tenant has 59 total user accounts. The user may select to migrate only 5 of the accounts, and the user may specify via the I/O module 162 which of the five will be migrated. Many additional parameters may be adjusted, including the number of Mailboxes, the number of OneDrive, the number of Teams Private Chat users, the number of Microsoft Teams, the number of Office 365 Groups, the number of DL/Security Groups, the number of Dynamic DLs, the number of Power Apps Level 1, the number of Power Apps Level 2, the number of Power Apps Level 3, the number of Power Automate Level 1, the number of Power Automate Level 2, the number of Power Automate Level 3, the number of Domains, the number of Exchange Transport Rules, the number of SharePoint Level 1, the number of SharePoint Level 2 and/or the number of SharePoint Level 3.

The user may further specify whether the assessment is to be an assessment only (i.e., dry run). The user may choose from a predetermined customer complexity matrix (e.g., low, medium or high); select a cutover type (phased or cutover); select from a migration type (e.g., merger, rebranding, sale/divestiture, etc.). The user may parameterize an number of engineers, an expected number of weeks to completion, a number of meetings with the client per week, etc.

Once the user has parameterized the content migration and resource migration parameters, the user may parameterize a set of services parameters. The services summary may display a number of components, within each includes multiple methodologies. For example:

| Component | Methodology |
|---|---|
| Discovery/Assessment | Source Environment Review Workshop; Target Environment Review |
| | Workshop; 3rd Party Cloud Discovery (per environment); Exchange - |
| | Discovery & Assessment; Public Folders; SharePoint - Discovery & |
| | Assessment; OneDrive - Discovery & Assessment; Teams - Discovery |
| | & Assessment; OfficeProPlus - Discovery & Assessment; Power |
| | Automate; Power Apps; PowerBI; Security and Compliance - |
| | Discovery & Assessment; Tenant Assessment Review; Misc (timebox); |
| Tenant Planning & | 3rd Party Cloud Planning and Design; Identity and Authentication |
| Design | Workshop; Exchange Online Workshop; OneDrive Workshop; Teams |
| | Collaboration Workshop; Teams Real Time Communication Workshop; |
| | Governance Workshop; Security and Compliance Workshop; |
| | Networking Workshop; Power Automate; Power Apps; Misc (timebox); |
| Migration Planning | 3rd Party Migration Planning; Exchange Workshop; Teams |
| | Collaboration Workshop; Teams Real Time Communication |
| | Workshop; OneDrive + SharePoint Workshop; Power Apps + Power |
| | Automate Workshop; Migration Resource Mapping |
| | Workshop/Support;; Migration Assessment, Design, and Strategy |
| | Documentation; Implementation Plan Documentation; Misc (timebox); |
| Configuration & Test | New Tenant Provisioning; AD Sync Build and Configuration; |
| | Configure Office 365/Azure AD Identity Features; DomD; Single |
| | Sign-On Support in target environment (one ADD option must be |
| | selected); +ADD: Seamless Single Sign-On; ADD: 3rd party SSO |
| | Support (per federated org); ADD: Azure SSO for catalog 3rd party |
| | solutions (per app); ADD: Azure SSO for 3rd party solutions w/config |
| | (per app); Exchange Online Build/Test; Exchange Hybrid Build and |
| | Configuration (per hybrid server); +ADD: Exchange Transport Rule |
| | Count; Email Re-write configuration with ODM; Email Re-write |
| | configuration with customer selected service; OneDrive/SharePoint |
| | Build/Test; Teams Build/Test; Teams Real Time Communication |
| | Build/Test; EndPoint Profile Migration Tool Build/Test; Power |
| | Platform Settings Build/Test; Build and Pilot - OneDrive Migration |
| | Tool; Build and Pilot - Email Migration Tool; Build and Pilot - Teams |
| | Migration Tool; Build and Pilot - SharePoint Migration Tool; Misc |
| | (timebox); |
| Domain Cutover | Number of domains being cutover; Test Users being migrated (up to |
| Test Run | 3); Test Mailboxes being migrated (up to 5); Test OneDrives being |
| | migrated (up to 3); Test O365 and MS Teams being migrated (up to 4); |
| | test SharePoint sites being migrated (up to 4); test Real Time |
| | Communication objects being migrated (up to 5); Test SMTP Relay |
| | Cutover; Test Email Cutover; Test Power App Cutover (per app); Test |
| | Power Automate Flow Cutover (per flow); Azure SSO Service |
| | Cutover (per app); Misc (timebox); |
| Deployment | Number of domains being cutover; Number of Migrations Waves (one |
| | or the other for each); +ADD: Recommended Day 1 Migration |
| | Support (Timebox); ADD: Migration Support (Timebox); ADD: |
| | Recommended Migration Support (Timebox); ADD: Migration |
| | Support (Timebox); Account Migration; Number of M365 groups and |
| | Teams; +ADD: Content Migration (GCP, Dropbox, ShareFile) 3rd |
| | Party - per repository; Teams - 1:1 & Private Chats(PER USER); |
| | Teams Channel Message Migration; Number of DLs and Security |
| | Groups being migrated; Number of Dynamic groups being migrated; |
| | Mailbox Migration (user/shared/resource); +ADD: Content Migration |
| | (Gmail, Rackspace, etc.) 3rd Party - per user; Total Mailbox Data |
| | (GBs); OneDrive For Business - File Content Migration; ADD: |
| | Content Migration (GCP, Dropbox, ShareFile) 3rd Party - per user; |
| | Total OneDrive Data (GBs); SharePoint Site Level 1 Migration; |
| | SharePoint Site Level 2 Migration; SharePoint Site Level 3 Migration; |
| | SharePoint Content Migration; SMTP Relay Cutover (per smtp relay |
| | server) - no application support; Public Folder Transition (Per 20 GB |
| | data); Count of Real Time Communication objects being migrated; |
| | Power App Level 1; Power App Level 2; Power App Level 3; Power |
| | Automate Level 1 Flow Cutover; Power Automate Level 2 Flow |
| | Cutover; Power Automate Level 3 Flow Cutover; Misc (timebox); |
| Adoption & Change | Basic Adoption Package - REQUIRED unless Essential or Premium |
| Management | Selected; Essential Adoption Package; Premium Adoption Package; |
| | Envisioning Add-On (Business Unit, Line of Business discussions - |
| | PREMIUM ONLY); End-User Enablement Add-On (Training, |
| | Custom Content, Per Hour); |
| Source Tenant | Number of Cleanup Waves; Account Cleanup (per account); M365 |
| Cleanup | groups and Teams Cleanup (per group); DLs and Security Groups |
| | Cleanup (per group); Dynamic groups Cleanup (per group); Mailbox |
| | Migration cleanup (user/shared/resource) (per mailbox); Public Folder |
| | Cleanup (TBD); OneDrive Cleanup (per OneDrive); SharePoint Site(s) |
| | Cleanup (per site); Power App Cleanup (per app); Power Automate |
| | Flow Cleanup (per flow); |

Within each component, and for each methodology, the user may specify, via the I/O module 162, for example, a respective parameter, or accept a default parameter. For example, the user may see that for the methodology “Email Re-write configuration with ODM” within “Configuration and Test” component, the hours per phase for a consultant are 4 by default, and project manager hours are 0.4 by default. The user may modify these parameters, or view them and keep the defaults. In some aspects, these defaults may be based on output of a trained machine learning model that has determined how much time such methodologies to complete on historical projects.

Once the user has accepted default parameters at the services summary and/or modified one or more of the services parameters, the user may access the financial calculator via the I/O module. The financial calculator may include hourly rates for personnel, such as an Associate, a Consultant, a Consultant (Senior), a Principal Consultant, a Technical Lead, a Project Architect, a Project Admin, Project Manager, a Sr. Project Manager, a Program Manager, etc. The hourly rates may include testing and evaluation (T&E) rates, adjustments to rates, standard rates, cost information, and effective rates. The user may parameterize any of this information. The financial calculator may also include resources costs, pricing and profit for the different respective personnel roles.

The financial calculator may include computations for each project type, based on total hours, and taking into account resource costs, travel costs, and total costs. On this basis the financial calculator may display to the user a total price, a gross profit and a profit margin percentage. The financial calculator may provide profit estimates for billed time and material inclusive or exclusive of T&E, and fixed fee inclusive/exclusive of a risk factor and T&E, in some aspects. In this way, the user can quickly compare which billing strategy may provide the best financial upside, and/or best limit costs.

In some aspects, the user may view and/or adjust via parameterization multipliers for different aspects of the migration project. For example, the user may view multipliers that relate to the following criteria: Number of Accounts, Number of O365 Groups, Number of Security/Distribution Groups, Number of Dynamic Groups, Number of Mailboxes, Number of OneDrive, Number of Teams Private Chat Users, Number of Accounts Cleanup, Number of Level 1 Flows, Number of Level 2 Flows, Number of Level 3 Flows, Number of Level 1 SharePoint Sites, Number of Level 2 SharePoint Sites, Number of Level 3 SharePoint Sites, Number of Level 1 Apps, Number of Level 2 Apps, Number of Level 3 Apps, etc.

Each of these multipliers may include multiple threshold numbers. For example, a multiplier, number of hours and cost per N may be set for each respective threshold. For example:

| Number of Level 2 Apps | | Multiplier | Hours | Cost per 100 |
|---|---|---|---|---|
| 4 | and under | 0 | | N/A |
| 15 | and under | 2 | 0.0 | 500 |
| 60 | and under | 2.7 | 0.0 | 250 |
| 200+ | and over | 1.9 | 0.0 | 120 |

The multipliers, hours and cost numbers may be determined via one or more trained ML model, such as a regression analysis. The aforementioned parameterization enables the user to generally view parameters that are already set and to parameterize some aspects of the migration project. However, in order to arrive at a realistic estimate of the costs and time involved, the user must understand the contours and composition of the environment to be migrated. Thus, the user may cause the results of the scanning to be integrated with the parameterized values, to generate an estimate of costs based on numbers from a live production environment (e.g., the tenant environment of the environment 100 of FIG. 1).

As noted above, the present techniques are highly advantageous, because they enable the user to modify parameters and view existing parameters, and to rigorously simulate the effect of changes on live data, without guesswork.

### Exemplary Tenant Summary Graphical User Interfaces

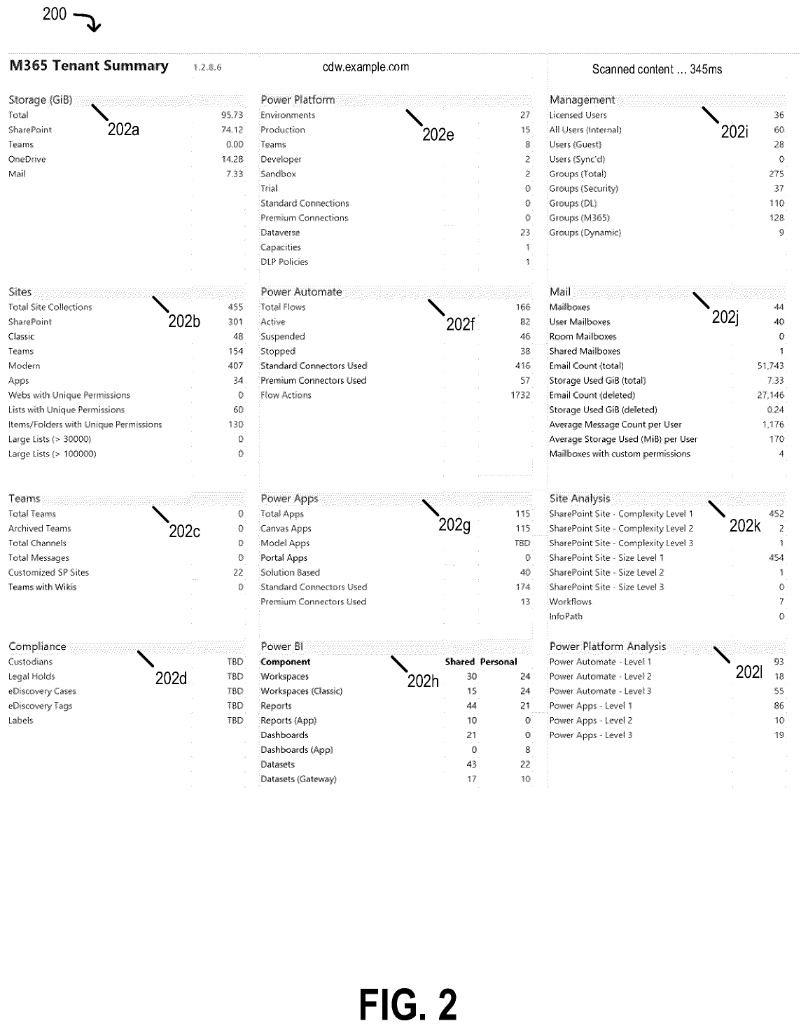

FIG. 2 depicts an exemplary tenant migration summary GUI 200, according to some aspects. The GUI 200 may be a web application displayed in a web browser, a mobile computing device application (e.g., an Android application iPhone application, etc.), an active spreadsheet application, etc. The GUI 200 may be generated by a server, such as the server 104 of FIG. 1. Generally, the tenant summary GUI 200 may comprise information related to one or more tenants (e.g., one or more customers or clients). The GUI 200 may include summary statistics generated by the resource/service scanner module 166 and the content scanner module 168, in addition to determinations/predictions of the ML models operated by the ML operation module 172 of FIG. 1.

For example, the GUI 200 may include a storage summary pane 202a that includes a total size of resources/content to be migrated, a total size of SharePoint data to be migrated, a total size of teams data to be migrated, a total size of OneDrive data to be migrated, and a total size of mail folders to be migrated, according to an aspect. The sizes in the summary pane 202 may be represented in any suitable size/capacity format (e.g., Gigabytes (GB), Gibibytes (GiB), etc.)

The GUI 200 may further include a sites summary pane 202b, a teams summary pane 202c, a compliance pane 202d, a power platform pane 202e, a power automate pane 202f, a power apps pane 202g, a power business intelligence (BI) pane 202h, a management pane 202i, a mail pane 202j, a site analysis pane 202k, and a power platform analysis pane 2061. In some aspects, other panes may be included.

Each of the panes 202a-2021 respectively depict a dimension of the given migration project as described above. Each of the panes includes a set of dynamic attributes, wherein each attribute includes a respective value. The value may be an aggregation (e.g., a count, sum, average, etc.) or the result of another, arbitrary, function. The values may be based on information determined by the content scanner module 168 and/or the resource/service scanner module 168 of FIG. 1. In some aspects, the information included in the GUI 200 may include the output of the resource/service scanner module 166 and/or the content scanner module 168 of FIG. 1. The information included in the GUI 200 may be based on performing computations on the example schemas discussed above, in some cases, using formulas embedded within those schemas.

For a simple example, the OneDrive storage size field of the storage summary pane 202a may be based on a sum of values from the OneDrive schema, for example the StorageUsed(GiB) field of that schema may be aggregated using a SUMO function.

For another example, the power automate pane 206f depicts 416 standard connectors used in the power automate portion of the tenant environment, as discovered by the resource/services scanner module 166. The number 416 is determined by counting the number of instances of standard flow connections discovered by the resource/services scanner module 166 by reference to the FlowConnections schema.

For yet another example, the power BI pane 202h may include a count of shared gateway dataset components. This count may be determined via a function that references multiple values of the BIDatasets schema:

=COUNTIFS(BIDatasets!B:B, “<>”,
BIDatasets!D:D,“Y”,BIDatasets!E:E,FALSE,BIDatasets!K:K,TRUE)

Many additional statistics are contemplated, beyond those discussed herein for exemplary purposes.

### Exemplary Tenant Summary Visualization

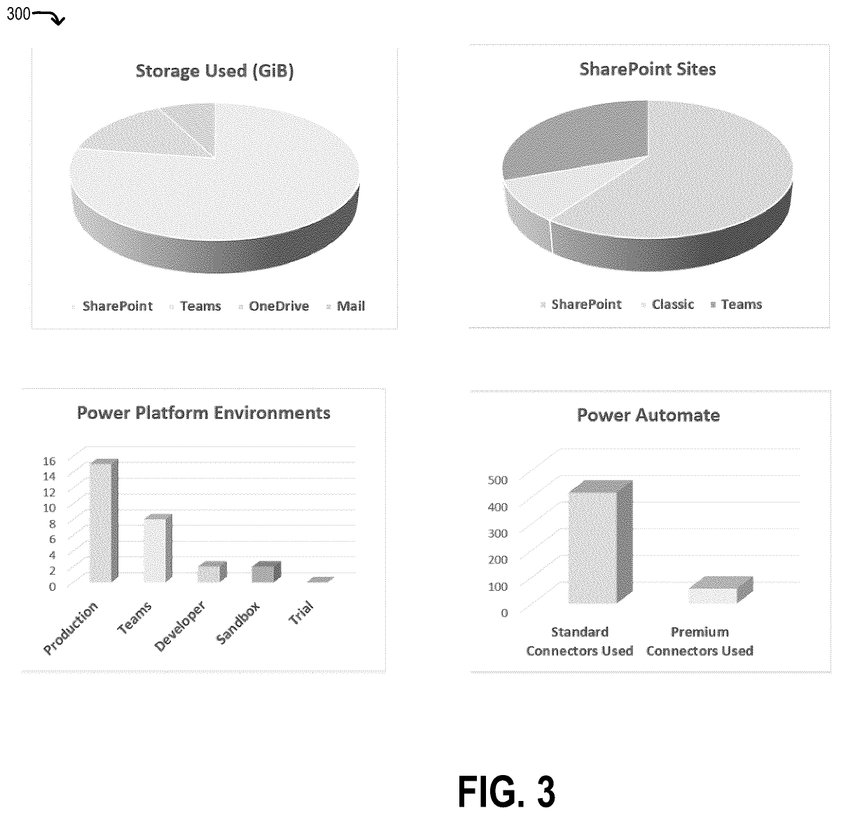

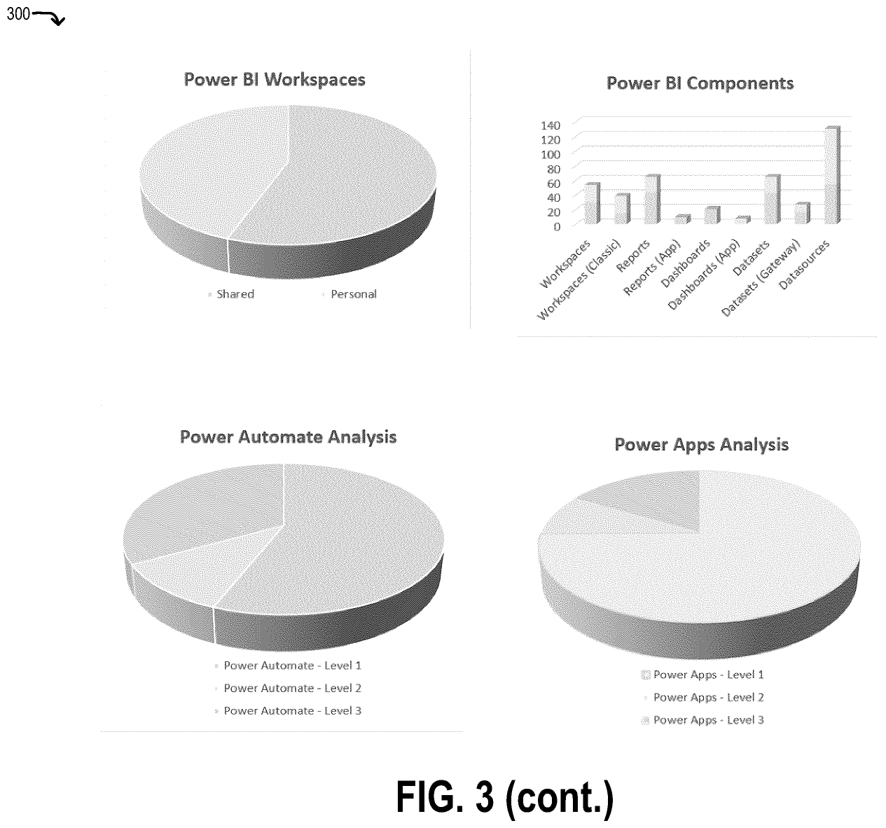

In some aspects, the present techniques may include visualizing information included in the GUI 200. For example, FIG. 3 depicts an exemplary tenant summary visualization GUI 300, according to some aspects. The GUI 300 may include one or more visualizations of the data included in the GUI 200, for example. In clockwise order, the depicted examples include visualizations, respectively, of information contained in the storage summary pane 202a the sites summary pane 202b, the power platform pane 202e, and the power automate pane 202f; and the power automate pane 202h, the power automate pane 202h, the power platform analysis pane 202l; and the power platform analysis pane 202l.

The visualizations depicted in FIG. 3 advantageously enable user to immediately view rich information in an easy-to-digest format that is significantly more informative than any conventional approaches, which rely on guessing. It will be appreciated by those of ordinary skill in the art that many visualization techniques are envisioned, including 2D-bar charts, pie charts, multi-dimensional bar charts, etc.

Thus, the present techniques enable the viewer of the GUI 200 and the GUI 300 to quickly and easily determine raw numbers related to the tenant resource use, and/or to gain an intuitive visual understanding of the resource use. Further, the GUI 200 and GUI 300 gather disparate information from the customer's tenant environment, and consolidate that information in one place. For example, while storage used may be available for viewing in a single computing instance of the tenant environment (e.g., the tenant computing device 102) the present techniques enable an administrator to gather all relevant metrics for the migration into a single place.

### Exemplary Computer-Implemented Methods

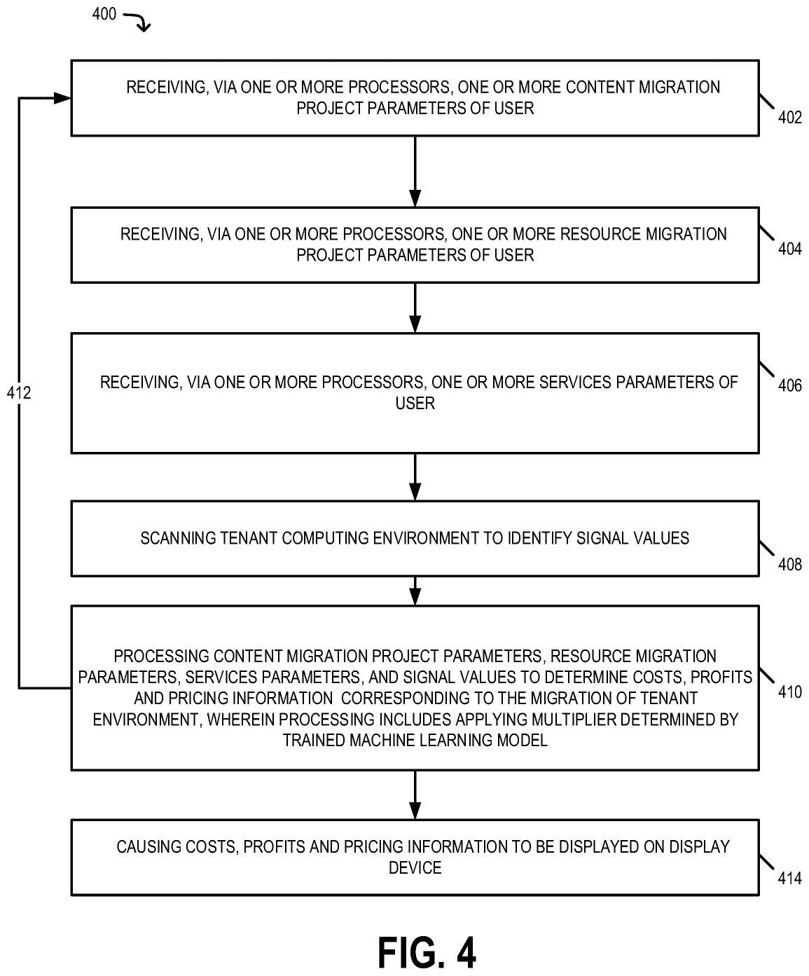

FIG. 4 depicts an exemplary computer-implemented method 400, according to some aspects.

The method 400 may include receiving, via the one or more processors, one or more content migration project parameters of a user (block 402). The content migration project parameters are discussed above with respect to FIG. 1. Specifically, the user may input via a GUI, parameters related to the migration assessment project, such as a migration project name (e.g., Example Migration), a migration project domain name/internet protocol (IP) address (e.g., http://exampleprodev.onmicrosoft.com), a portal uniform resource locator (URL) (e.g., http://exampleportal.sharepoint.com), a root site URL (e.g., http://example.sharepoint.com), an administrator URL (e.g., http://example-admin.sharepoint.com), one or more site URL (e.g., http://example-site.sharepoint.com), a default location toggle, etc.

Further, as discussed, the user may provide and/or override content migration parameters such as the amount of data to migrate, the ShareGate Server Count, the mailbox data to migrate, etc. The user may reduce default values to smaller numbers, in some aspects.

The method 400 may include receiving, via the one or more processors, one or more resource migration project parameters of a user (block 404). As discussed, the user may further enter parameters related to the customer complexity matrix, cutover type, target tenant, etc.

The method 400 may include receiving, via the one or more processors, one or more services parameters of a user (block 406). As discussed, the services parameters may include one or more components, each having a plurality of methodologies. Each methodology may include predefined values for consultant and project manager hours per phase, for example. The user may override these values by making them larger or smaller. The user may also set a boolean flag in some aspects that defines whether a given component/methodology is to be included in computation of the financial aspects of the migration.

The method 400 may include scanning a tenant computing environment to identify, for each of a plurality of schemas, one or more respective signal values; (block 408). As discussed, many methods of performing scanning of the tenant environment are envisioned. As will be appreciated by those of ordinary skill in the art, many tools exist that may for the basis of such scanning exist, such as packet sniffing, Windows Auto-Discovery, Apple Bonjour, ARP spoofing, NMAP, Metasploit, Nessus, Cobalt strike, etc. In some aspects, a proprietary solution may be used. Those of ordinary skill in the art will appreciate that the correct tool for the scanning/network surveillance job may depend upon the properties of the client's tenant environment. What is certain, however, is that any of these are an improvement over blindly guessing.

The method 400 may include processing the content migration project parameters, the resource migration parameters, the services parameters, and the respective signal values to determine costs, profits and pricing information corresponding to the migration of the tenant environment, wherein the processing includes applying at least one multiplier determined by a trained machine learning model; and (block 410). As discussed, one or more neural networks may process historical data to generate, for example, a regression analysis of prior migrations, to determine predicted cost and/or time involved, given one or more inputs.

The method 400 may include causing the costs, profits and pricing information to be displayed on a display device. (block 414). By displaying this information, the method 400 enables the user to revise the entered parameters, and to simulate the migration again. This capability is very advantageous, because it can be used to provide decision-makers with key information before precious resources are deployed in a migration project.

In some aspects, the method 400 may include processing the one or more respective signal values using one or more forumlas embedded in the schemas to determine dynamic respective signal values. Specifically, the schemas may include formulas that are evaluated and that access values of other values. For example, as shown in the above examples, the formulas may include aggregation, math operations (SUM, AVERAGE, multiplication, etc.), conditionals, etc.

In some aspects, the method 400 may include crawling the root site uniform resource location of the SharePoint site to discover one or more sub-sites belonging to the SharePoint site; and generating one or more respective signals corresponding to each of the sub-sites.

In some aspects, the method 400 may include generating a schema corresponding to the discovered sub-sites; and storing the signals in the schema. In some aspects, the method 400 may include generating a separate schema for one or more of the discovered sub-sites. In this case, the same schemas may be repeated for multiple sub-sites, each having different respective values. In some aspects, the method 400 may include scanning the tenant environment to identify at least one of a page, a workflow, an infopath, a web permission, a site group, a team, a team channel, a team member, a OneDrive installation, a user, a group, a group member, a mail message, an environment, a dataverse, a flow, a flow connection, a power application, a power application connection, a capacity, a license or a business intelligence workspace.

In some aspects, the method 400 may include training the machine learning model by processing labeled historical migration log files. For example, the multi-brand provider of information technology solutions may have an incidental data set of log files corresponding to historical migrations. The solutions provider may have built this data set up unwittingly by employees practicing the conventional techniques discussed above. In some aspects, this data may be curated so that each migration project includes a label and a set of actions that were performed during the migration to properties of the company whose tenant environment was migrated during the conventional process. In some aspects, the historical data may be mapped to the above-described schemas, so as to be directly comparable to schemas generated using the present techniques. These labeled schemas may be input into a ML model to train that model to predict, given the historical data, how much time, resources, and/or expense would be required to complete a migration having certain properties as defined in a schema. The prediction may take the form of a regression value output, in some aspects.

In some aspects, the method 400 may include generating one or more visualizations corresponding to the respective signal values; and causing the visualizations to be displayed on a display device. Visualizations were discussed and exemplified above with respect to FIG. 4. As discussed, many additional visualizations are envisioned.

### ADDITIONAL CONSIDERATIONS

The following considerations also apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

It should also be understood that, unless a term is expressly defined in this patent using the sentence “As used herein, the term” “is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one aspect” or “an aspect” means that a particular element, feature, structure, or characteristic described in connection with the aspect is included in at least one aspect. The appearances of the phrase “in one aspect” in various places in the specification are not necessarily all referring to the same aspect.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the aspects herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for implementing the concepts disclosed herein, through the principles disclosed herein. Thus, while particular aspects and applications have been illustrated and described, it is to be understood that the disclosed aspects are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed:

1. A computing system for improved migration of a tenant environment, comprising:
one or more processors; and
a memory having stored thereon instructions that, when executed by the one or more processors, cause the system to:
receive, via the one or more processors, one or more content migration project parameters of a user;
receive, via the one or more processors, one or more resource migration project parameters of a user;
receive, via the one or more processors, one or more services parameters of a user;
scan a tenant computing environment to identify, for each of a plurality of schemas, one or more respective signal values;
process the content migration project parameters, the resource migration parameters, the services parameters, and the respective signal values to determine costs, profits and pricing information corresponding to the migration of the tenant environment, wherein the processing includes applying at least one multiplier determined by a trained machine learning model; and
cause the costs, profits and pricing information to be displayed on a display device.

2. The computing system of claim 1, the memory having stored thereon instructions that, when executed by the one or more processors, cause the system to:
process the one or more respective signal values using one or more formulas embedded in the schemas to determine dynamic respective signal values.

3. The computing system of claim 1, wherein the tenant environment includes a Microsoft SharePoint site, and the memory having stored thereon instructions that, when executed by the one or more processors, cause the system to:
crawl the root site uniform resource location of the SharePoint site to discover one or more sub-sites belonging to the SharePoint site; and
generate one or more respective signals corresponding to each of the sub-sites.

4. The computing system of claim 3, the memory having stored thereon instructions that, when executed by the one or more processors, cause the system to:
generate a schema corresponding to the discovered sub-sites; and
store the signals in the schema.

5. The computing system of claim 1, the memory having stored thereon instructions that, when executed by the one or more processors, cause the system to:
scan the tenant environment to identify at least one of a page, a workflow, an infopath, a web permission, a site group, a team, a team channel, a team member, a OneDrive installation, a user, a group, a group member, a mail message, an environment, a dataverse, a flow, a flow connection, a power application, a power application connection, a capacity, a license or a business intelligence workspace.

6. The computing system of claim 1, the memory having stored thereon instructions that, when executed by the one or more processors, cause the system to:
train the machine learning model by processing labeled historical migration log files.

7. The computing system of claim 1, the memory having stored thereon instructions that, when executed by the one or more processors, cause the system to:
generate one or more visualizations corresponding to the respective signal values; and
cause the visualizations to be displayed on a display device.

8. A computer-implemented method for improved migration of a tenant environment, comprising:
receiving, via the one or more processors, one or more content migration project parameters of a user;
receiving, via the one or more processors, one or more resource migration project parameters of a user;
receiving, via the one or more processors, one or more services parameters of a user;
scanning a tenant computing environment to identify, for each of a plurality of schemas, one or more respective signal values;
processing the content migration project parameters, the resource migration parameters, the services parameters, and the respective signal values to determine costs, profits and pricing information corresponding to the migration of the tenant environment, wherein the processing includes applying at least one multiplier determined by a trained machine learning model; and
causing the costs, profits and pricing information to be displayed on a display device.

9. The computer-implemented method of claim 8, wherein processing the content migration project parameters, the resource migration parameters, the services parameters, and the respective signal values to determine costs, profits and pricing information corresponding to the migration of the tenant environment includes processing the one or more respective signal values using one or more forumlas embedded in the schemas to determine dynamic respective signal values.

10. The computer-implemented method of claim 8, wherein the tenant environment includes a Microsoft SharePoint site, and further comprising:
crawling the root site uniform resource location of the SharePoint site to discover one or more sub-sites belonging to the SharePoint site; and
generating one or more respective signals corresponding to each of the sub-sites.

11. The computer-implemented method of claim 10, further comprising:
generating a schema corresponding to the discovered sub-sites; and storing the signals in the schema.

12. The computer-implemented method of claim 8, wherein scanning the tenant computing environment to identify, for each of the plurality of schemas, the one or more respective signal values includes scanning the tenant environment to identify at least one of a page, a workflow, an infopath, a web permission, a site group, a team, a team channel, a team member, a OneDrive installation, a user, a group, a group member, a mail message, an environment, a dataverse, a flow, a flow connection, a power application, a power application connection, a capacity, a license or a business intelligence workspace.

13. The computer-implemented method of claim 8, wherein processing the content migration project parameters, the resource migration parameters, the services parameters, and the respective signal values to determine costs, profits and pricing information corresponding to the migration of the tenant environment includes training the machine learning model by processing labeled historical migration log files.

14. The computer-implemented method of claim 8, further comprising
generating one or more visualizations corresponding to the respective signal values; and
causing the visualizations to be displayed on a display device.

15. A non-transitory computer readable medium containing program instructions that when executed, cause a computer to:
receive, via the one or more processors, one or more content migration project parameters of a user;
receive, via the one or more processors, one or more resource migration project parameters of a user;
receive, via the one or more processors, one or more services parameters of a user;
scan a tenant computing environment to identify, for each of a plurality of schemas, one or more respective signal values;
process the content migration project parameters, the resource migration parameters, the services parameters, and the respective signal values to determine costs, profits and pricing information corresponding to the migration of the tenant environment, wherein the processing includes applying at least one multiplier determined by a trained machine learning model; and
cause the costs, profits and pricing information to be displayed on a display device.

16. The non-transitory computer readable medium of claim 15, containing further program instructions that when executed, cause a computer to:
process the one or more respective signal values using one or more forumlas embedded in the schemas to determine dynamic respective signal values.

17. The non-transitory computer readable medium of claim 15, containing further program instructions that when executed, cause a computer to:
crawl the root site uniform resource location of the SharePoint site to discover one or more sub-sites belonging to the SharePoint site; and
generate one or more respective signals corresponding to each of the sub-sites.

18. The non-transitory computer readable medium of claim 15, containing further program instructions that when executed, cause a computer to:
generate a schema corresponding to the discovered sub-sites; and
store the signals in the schema.

19. The non-transitory computer readable medium of claim 15, containing further program instructions that when executed, cause a computer to:
train the machine learning model by processing labeled historical migration log files.

20. The computing system of claim 1, the memory having stored thereon instructions that, when executed by the one or more processors, cause the system to:
generate one or more visualizations corresponding to the respective signal values; and
cause the visualizations to be displayed on a display device.
